(19) United States
(12) Patent Application Publication
(10) Pub. No.: US 2016/0237917 A1
(43) Pub. Date: Aug. 18, 2016

(54) METHOD FOR OPTIMISING THE SPECIFIC CONSUMPTION OF A TWIN HELICOPTER

(71) Applicant: TURBOMECA, Bordes (FR)

(72) Inventors: Patrick MARCONI, Gelos (FR); Romain THIRIET, Jurancon (FR)

(21) Appl. No.: 15/025,456

(22) PCT Filed: Oct. 3, 2014
(86) PCT No.: PCT/FR2014/052508

§ 371 Date: Mar. 28, 2016

(30) Foreign Application Priority Data
Oct. 9, 2013 (FR) 1359766

(51) Int. Cl. F02C 9/42; B64D 27/10; F01D 15/08; F02C 3/04; F01D 15/12; B64C 27/04; F02C 7/262

(52) U.S. Cl. CPC F02C 9/42; B64C 27/04; B64D 27/10; F02C 7/262; F02C 3/04; F01D 15/12; F01D 15/08; F05D 2220/329; F05D 2240/35

(57) ABSTRACT

Method for optimising the specific consumption of a helicopter equipped with two turboshaft engines (1, 2) which each comprise a gas generator (11, 21) provided with a combustion chamber (CC), each of these turboshaft engines (1, 2) being capable of operating on its own at a continuous flight speed, the other turboshaft engine (2, 1) therefore being at a speed referred to as super-idle at zero power, and, while the combustion chamber (CC) is ignited, this super-idle speed being assisted by the shaft (AE) of the gas generator being mechanically driven in rotation at this speed, so as to reduce the operating temperature and the fuel consumption of this gas generator.

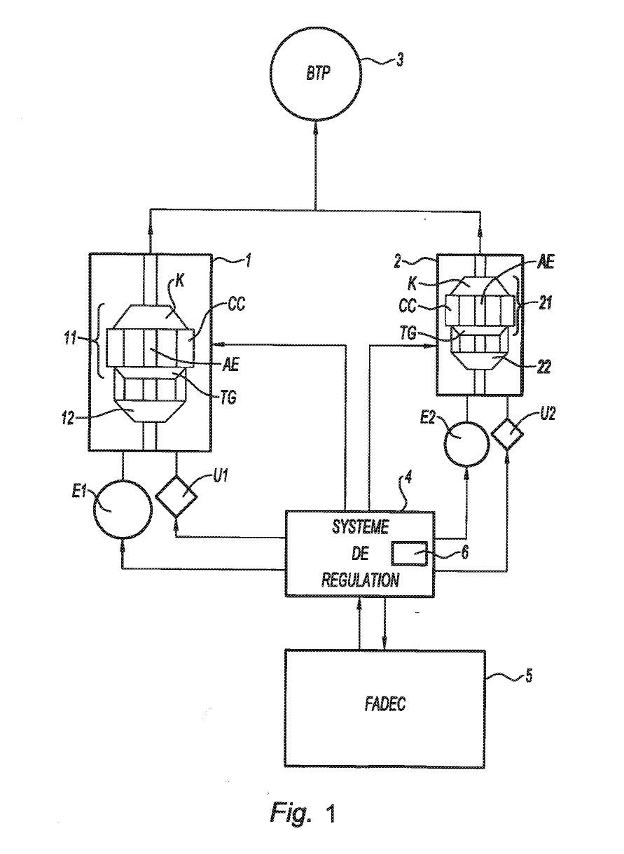

### TECHNICAL FIELD

The present invention relates to a method for optimising the specific consumption of a twin-engine helicopter, that is to say of a helicopter equipped with two turboshaft engines.

### PRIOR ART

Generally, at cruising speed, the turboshaft engines operate at low power levels, below their maximum continuous power (MCP). At cruising speed, this power is equal to approximately 50% of their maximum take-off power (MTOP). These low power levels lead to a specific consumption Cs of approximately 30% greater than the Cs at the MTOP, and therefore to overconsumption of fuel at cruising speed.

A helicopter is equipped with two turboshaft engines, each engine being oversized in order to be able to keep the helicopter in the air if the other engine fails. In these operating modes that are dedicated to managing an inoperative engine, referred to as a one engine inoperative (OEI) mode, the engine that is still in operation provides a power that is well above its rated power in order to allow the helicopter to cope with a dangerous situation and then to be able to continue its flight. Each mode is defined by a power level and a maximum usage duration. The flow rate of fuel injected into the combustion chamber of the turboshaft engine that is still in operation is therefore substantially increased at OEI speed in order to provide this excess power.

These oversized turboshaft engines are disadvantageous in terms of mass and fuel consumption. In order to reduce this consumption at cruising speed, it is possible to stop one of the turboshaft engines. The active engine therefore operates at a higher power level and therefore at a more favourable Cs level. However, this practice is contrary to the current certification rules, and turboshaft engines are not designed to ensure a level of restart reliability that is compatible with safety standards.

Therefore, the restart duration of the turboshaft engine in standby mode is typically approximately thirty seconds. This duration may prove to be insufficient depending on the flight conditions, for example at a low flight altitude with a partial malfunction of the initially active engine. If the engine in standby mode does not restart in time, landing using the faulty engine may prove to be critical.

More generally, the use of a single turboshaft engine carries risks in all flight situations in which it is necessary to have excess power available which requires two turboshaft engines to be available for safety reasons.

The applicant has already proposed, in FR-A1-2 967 133, a method for optimising the specific consumption of a helicopter equipped with two turboshaft engines which each comprise a gas generator provided with a combustion chamber. At least one of the turboshaft engines is capable of operating on its own at a stabilised flight speed referred to as a continuous speed, the other turboshaft engine therefore being capable of passing, at a speed referred to as super-idle at zero power, into a mode for accelerating the gas generator of this turboshaft engine by means of compatible driving together with a restart in an emergency output.

The rotational speed of the gas generator of the turboshaft engine at super-idle speed remains substantially less than the rotational speed of the gas generator at idle speed that is usually applied to turboshaft engines. When idle, the free turbine of the turboshaft engine has its rotational speed maintained by the system for controlling the turboshaft engine at its rated value while at super-idle speed, the free turbine is uncoupled from the helicopter rotor and no longer rotates at its rated rotational speed.

A continuous speed is defined by an unlimited duration and therefore does not relate to the transitional phases of take-off, hovering flight and landing. For example, in a search mission for shipwreck survivors, a continuous speed relates to the flight phase of cruising towards the search area, to the low-altitude flight phase in the search area above the water and to the cruising-flight phase of returning to base. For safety reasons, the two turboshaft engines preferably operate together during the transitional phases of take-off, hovering flight and landing.

However, selectively using the turboshaft engines depending on the flight phases and conditions other than the transitional phases makes it possible to achieve performance that is optimised in terms of consumption Cs together with power that is close to the MTOP but less than or equal to the MCP, while coping with cases of failure and emergency using reliable means for restarting the turboshaft engine at super-idle speed.

Changing from a super-idle speed to an active “twin-engine” speed is triggered in a “normal” manner when a change in flight speed requires passage from one to two engines, for example when the helicopter passes from a cruising speed into hovering flight, or in an “emergency” manner if the engine fails or in the event of flight conditions which have suddenly become difficult.

In the above-mentioned prior application, the super-idle speed is selected from a speed for keeping the engine in rotation where the combustion chamber is ignited, a speed for keeping the engine in rotation where the combustion chamber is not ignited and a zero-rotational speed of the engine where the combustion chamber is not ignited.

When the combustion chamber is not ignited, it is not supplied with fuel. The fuel consumption of a turbine engine at super-idle speed of this type may therefore be substantially zero. The rotation of the shaft of the generator is ensured by drive means.

The present invention proposes an improvement in the case in which the combustion chamber of the gas generator of the turboshaft engine at super-idle speed is ignited.

Indeed, the applicant has noted that the operating temperature and the fuel consumption of the gas generator are particularly high at super-idle speed when the chamber is ignited. It is ensured that the rotation of the shaft of the gas generator is maintained solely by supplying the combustion chamber of this generator with fuel, which is thus ignited and feeds the high-pressure (HP) turbine of the generator. This turbine provides a relatively high amount of mechanical work for driving the compressor, and this leads to a relatively high inlet temperature of said compressor and a relatively high temperature in the chamber. The operating temperature at super-idle speed is close to that during take-off. Since the flow rate of gas circulating in the generator is lower at super-idle speed, the generator is relatively hotter than during take-off, and this may pose problems relating to cooling and therefore to the service life of the components.

The present invention provides a simple, effective and economical solution to this problem.

### DISCLOSURE OF THE INVENTION

To this end, the invention proposes a method for optimising the specific consumption of a helicopter equipped with two turboshaft engines which each comprise a gas generator provided with a combustion chamber, each of these turboshaft engines being capable of operating on its own at a continuous flight speed, the other turboshaft engine therefore being capable of passing, at a speed referred to as super-idle at zero power, into a mode for accelerating the gas generator of this turboshaft engine by means of compatible driving together with a restart in an emergency output, characterised in that this super-idle speed is obtained while the combustion chamber of the gas generator is ignited, and in that this super-idle speed is assisted by the shaft of the gas generator being mechanically driven in rotation at this speed, so as to reduce the operating temperature and the fuel consumption of this gas generator.

According to the invention, this super-idle speed (non-zero rotational speed with chamber ignited) is assisted by providing the gas generator with mechanical power with the aim of significantly reducing the operating temperature and the fuel consumption at this speed, which in particular makes it possible to minimise the quantity of unburned fuel that is discharged. Indeed, providing mechanical power to the shaft of the gas generator reduces the mechanical work that needs to be provided to the HP turbine in order to drive the compressor, and this leads to a reduction in the inlet temperature thereof and thus in all the temperatures observed downstream of the turbine as far as the exhaust, which has a positive effect on the service life of the components subjected to these temperatures, including in the immediate vicinity of the engine. This reduction in the temperature also leads to a reduction in the temperature in the combustion chamber and in fuel consumption.

The super-idle speed may correspond to approximately 10 to 40% of the rated speed of the gas generator. The super-idle speed is therefore different from the standard idle speeds (flight idle and ground idle), which generally correspond to 70 to 80% of the rated speed of the gas generator.

The super-idle speed is preferably continuously assisted, that is to say that the shaft of the gas generator is driven in rotation over the entire duration for which the engine is at super-idle speed, without interruption.

The mechanical driving is for example provided by an electric motor, a mechanical drive device that is coupled to the other gas generator or to the rotor of the helicopter, or a mechanical drive device that operates using a power source such as a hydraulic or pneumatic source. The electric motor may be a starter which is provided on the gas generator and is supplied with power by an on-board network or a starter/generator provided on the other gas generator. The mechanical drive device may be coupled to a power transfer box (PTB) or directly to the free turbine of the other generator.

### DESCRIPTION OF THE FIGURES

The invention will be better understood and further details, features and advantages of the invention will become apparent upon reading the following description, given by way of non-limiting example, and with reference to the single FIGURE, which is a simplified diagram of an example twin-engine architecture for implementing the method according to the invention.

### DETAILED DESCRIPTION

The terms “engine” and “turboshaft engine” are used synonymously in this document. In the embodiment shown, the engines have differentiated maximum powers. This embodiment advantageously makes it possible to suppress the OEI speeds on the more powerful turboshaft engine, and this minimises the difference in mass between the two engines. In order to simplify the language, the most powerful engine or the oversized engine may also be referred to as the “large” engine and the least powerful engine may be referred to as the “small” engine.

The FIGURE schematically shows an example helicopter twin-engine architecture which makes it possible to optimise the specific consumption Cs.

Each turboshaft engine 1, 2 conventionally comprises a gas generator 11, 21 and a free turbine 12, 22 that is fed by the gas generator in order to provide power. During take-off and at continuous speed, the power supplied may reach predetermined maximum values MTOP and MCP respectively. A gas generator is conventionally made up of air compressors “K” which are connected to a chamber “CC” for combusting the fuel in the compressed air and supply gases that provide kinetic energy, and of turbines for partially expanding these gases “TG” which drive the compressors in rotation via the drive shafts “AE”. The gases also drive the free power-transmission turbines. In the example, the free turbines 12, 22 transmit power via a PTB 3 which centralises the provision of power to the loads and accessories (power take-off of the rotor, pumps, alternators, starter/generator device, etc.).

The maximum powers MTOP and MCP of the turboshaft engine 1 are substantially greater than those that the turboshaft engine 2 is able to provide: the turboshaft engine 1 is oversized in terms of power compared with the turboshaft engine 2. The heterogeneity ratio between the two turboshaft engines, which corresponds to the ratio between the power of the highest OEI speed of the turboshaft engine 2 and the maximum MTOP power of the turboshaft engine 1, is equal to 1:3 in the example.

Alternatively, the two turboshaft engines 1 and 2 may be identical and the maximum MTOP and MCP powers of these turboshaft engines are therefore also identical.

Each turboshaft engine 1, 2 is coupled to drive means E1 and E2 and to emergency assistance devices U1 and U2.

Each means E1, E2 for driving the relevant gas generator 11, 21 in rotation is in this case formed by a starter which is supplied with power in each case by a starter/generator device provided on the other turboshaft engine. In addition, in this example, each emergency assistance device U1, U2 advantageously comprises glow plugs as a near-instantaneous ignition device, in a complementary manner to conventional plugs, and a propellant cartridge that feeds an auxiliary micro-turbine as a mechanical means for accelerating gas generators. This complementary ignition device may also be used with a normal output for changing the flight speed, or in an emergency output of the super-idle speed.

During operation, these drive means E1, E2, the emergency assistance devices U1, U2 and the controllers of the turboshaft engines 1 and 2 are managed by means for activating a control system 4, under the control of the full authority digital engine control (FADEC) system 5.

The control system 4 comprises a memory 6 in which management modes that are specific to different mission profiles are stored. From these management modes, the system 4 selects those modes which are suited to the profile of the current mission, such as a mode M1 relating to transitional phases, a mode M2 relating to flights at continuous speed (cruising and search phase), a mode M3 relating to engine failures and a mode M4 for managing emergency restarts of the engines at super-idle speed.

During the transitional phases (mode M1), such as take-off, hovering flight and landing, the turboshaft engines 1 and 2 are both in operation, so that the helicopter has a high level of power available which may be up to the MTOP of said engines. The two engines operate at the same relative level of power compared with the rated power thereof. The cases in which one of the engines fails are managed in a conventional manner, for example by activating the OEI speeds of the “small” turboshaft engine or of the turboshaft engine that is still in operation in the event of the failure of the other turboshaft engine.

The mode M3 manages the cases of failure of the engine being used by reactivating the other engine by means of its emergency assistance device. For example, when the oversized turboshaft engine 1, which is used in stand-alone operation during the cruising-flight phases, fails, the “small” engine 2 is rapidly reactivated by means of its emergency assistance device U2. Similarly, if the “small” engine 2, which is in stand-alone operation during the search phase, fails, the “large” engine 1 is rapidly reactivated by means of its emergency assistance device U1. The same applies when the engines are identical in terms of power.

When the flight conditions suddenly become difficult, a rapid restart of the engine at super-idle speed, by activating its assistance device, may be advantageous for providing power to the two turboshaft engines. In the example, this device is pyrotechnic in nature and is made up of a propellant cartridge that feeds a micro-turbine. These cases are managed by the emergency restart mode M4. Therefore, whether it be during the cruising-flight phase or search phase, during which a single turboshaft engine 1 or 2 is in operation, the operation of the other turboshaft engine 2 or 1 is triggered by activating the relevant pyrotechnic assistance device U2 or U1 only if the conventional restart means fail. The flight conditions are therefore rendered safe by the helicopter being operated in twin-engine mode.

In the reference mission, continuous flight corresponds to the cruising-flight phases and the flight phases for searching at low altitude. These phases are managed by the mode M2, which provides for the operation of one turboshaft engine while the other turboshaft engine is at super-idle speed and is kept in rotation while its combustion chamber is ignited.

This configuration corresponds to the power requirement which, in these cruising phases, is less than the MCP of the “large” engine 1 and greater than that of the “small” engine 2. At the same time, with regard to the consumption Cs, this solution is also advantageous since the large engine 1 operates at a level of relative power that is greater than in a conventional mode in which the two engines are in operation. When the engines are identical, the power requirement in these cruising phases may not exceed the MCP of the engines.

In the search phase C, the “small” turboshaft engine 2 having the lowest power operates in a stand-alone manner since it is capable of meeting the power requirement by itself. Indeed, the requirement is therefore substantially less than the power MCP of the oversized turboshaft engine 1, but also less than the MCP of the “small” engine 2. However, in particular, the consumption Cs is lower since this “small” engine 2 operates at a higher level of relative power than that at which the turboshaft engine 2 would have operated. In this phase C, the turboshaft engine 1 is kept at super-idle speed, for example in rotation, by the starter used as a means E1 for driving at an advantageous chamber-ignition speed.

Alternatively, in the case of engines having the same power, just one of the two engines is in operation, the other being kept at super-idle speed.

According to the invention, the gas generator of the turboshaft engine at super-idle speed is assisted by its shaft AE being mechanically driven in rotation, so as to reduce the operating temperature and fuel consumption.

In the case shown, the shaft AE of the gas generator 21 is driven by means of its starter (drive means E2), which is supplied with power by the starter/generator (drive means E1) of the other gas generator 11. As shown above, the drive means E1, E2 are managed by the means for activating the control system 4. Providing mechanical power to the shaft AE of the gas generator 21 reduces the mechanical work that needs to be provided by its turbine TG in order to drive the compressor K, which leads to a reduction in the inlet temperature thereof and in the temperature in the combustion chamber CC. The rotation of the generator is maintained both by the mechanical driving and a flow rate of fuel for feeding the chamber, it being possible for said flow rate to be relatively low compared with the prior art, and this limits the fuel consumption.

1. Method for optimising the specific consumption of a helicopter equipped with two turboshaft engines which each comprise a gas generator provided with a combustion chambers, each of these turboshaft engines being capable of operating on its own at a continuous flight speed, the other turboshaft engine therefore being capable of passing, at a speed referred to as super-idle at zero power, into a mode for accelerating the gas generator of this turboshaft engine by means of compatible driving together with a restart in an emergency output, characterised in that this super-idle speed is obtained while the combustion chamber of the gas generator is ignited, and in that this super-idle speed is assisted by the shaft of the gas generator being mechanically driven in rotation at this speed, so as to reduce the operating temperature and the fuel consumption of this gas generator.

2. Optimisation method according to claim 1, characterised in that the assistance is continued without interruption over the entire duration for which the engine is at super-idle speed.

3. Optimisation method according to claim 1, characterised in that the super-idle speed corresponds to approximately 10 to 40% of the rated speed of the gas generator at this speed.

4. Optimisation method according to claim 1, characterised in that the mechanical driving is provided by an electric motor, a mechanical drive device that is coupled to the other gas generator or to the rotor of the helicopter, or a mechanical drive device that operates using a power source such as a hydraulic or pneumatic source.
